(19) United States
(12) Patent Application Publication
(10) Pub. No.: US 2012/0176212 A1
(43) Pub. Date: Jul. 12, 2012

(54) METHOD AND SYSTEM FOR PRODUCING SINTERED NdFeB MAGNET, AND SINTERED NdFeB MAGNET PRODUCED BY THE PRODUCTION METHOD

(75) Inventors: Masato Sagawa, Kyoto-shi (JP); Tetsuhiko Mizoguchi, Kyoto-shi (JP); Michiyasu Asazuma, Nagaokakyo-shi (JP); Shinichi Hayashi, Kyoto-shi (JP)

(73) Assignee: INTERMETALLICS CO., LTD., Kyoto-shi, Kyoto (JP)

(21) Appl. No.: 13/392,311

(22) PCT Filed: Aug. 27, 2010
(86) PCT No.: PCT/JP2010/064558

§ 371 Date: Mar. 21, 2012

(30) Foreign Application Priority Data
Aug. 28, 2009 (JP) 2009-197932
Apr. 23, 2010 (JP) 2010-100268

(51) Int. Cl. H01F 7/02; B22F 3/10; B22F 1/00

(52) U.S. Cl. 335/302; 419/30; 425/3

(57) ABSTRACT

A method and system for producing a slim-shaped sintered NdFeB magnet having a high level of coercive force and high degree of orientation, as well as a sintered NdFeB magnet produced by the aforementioned method or system. A system for producing a slim-shaped sintered NdFeB magnet according to the present invention includes: a filling unit and filling alloy powder; an orienting unit; a sintering furnace; and a conveying unit. The orienting unit is provided with a heating and orienting coil for heating the alloy powder in the molds before and/or after the application of the magnetic field so as to decrease the coercive force of the individual particles of the alloy powder.

### TECHNICAL FIELD

The present invention relates to a method and system for producing a slim-shaped sintered NdFeB magnet having excellent magnetic properties, and particularly a high level of coercivity and high degree of orientation. It also relates to a sintered NdFeB magnet produced by the aforementioned method.

### BACKGROUND ART

A sintered NdFeB (neodymium-iron-boron) magnet, which was discovered by Sagawa (one of the present inventors) et al. in 1982, is characterized in that its properties are far superior to any previously used permanent magnets and yet it can be produced from relatively abundant, inexpensive materials, i.e. neodymium (a rare-earth element), iron and boron. Due to these merits, this magnet is currently used in various products, such as the voice coil motors for hard disk drives or similar devices, drive motors for hybrid cars or electric cars, motors for battery-assisted bicycles, industrial motors, high-quality speakers, head phones, and magnetic resonance imaging (MRI) apparatuses using permanent magnets.

Three methods have been previously known to be available for producing NdFeB sintered magnets: (1) a sintering method; (2) a method including the process steps of casting, hot working and aging; and (3) a method including the step of die upsetting of a rapidly cooled alloy. Among these methods, the sintering method is superior to the other two in terms of magnetic properties and productivity and has already been established on the industrial level. With the sintering method, a dense, uniform and fine structure necessary for permanent magnets can be obtained.

Patent Document 1 discloses a method for producing a sintered NdFeB magnet by a sintering method. A brief description of this method is as follows: Initially, an NdFeB alloy is created by melting and casting. This alloy is pulverized into fine powder and filled into a mold. A magnetic field is applied to this alloy powder, while pressure is applied to the powder with a pressing machine. In this manner, both the creation of a compact and the magnetic orientation of the compact are simultaneously performed. Subsequently, the compact is removed from the mold and heated for sintering to obtain a sintered NdFeB magnet.

Fine powder of an NdFeB alloy is easily oxidized and can ignite by reacting with oxygen in air. Therefore, the previously described process should preferably be performed entirely in an airtight container whose internal space is free from oxygen or filled with inert gas. However, this is impractical because creating the compact requires a large-sized pressing machine capable of applying a high pressure of tens or hundreds MPa to the alloy powder. Such a pressing machine is difficult to be set within an airtight container.

Patent Document 2 discloses a method for producing a sintered magnet without using a pressing machine (i.e. without creating a compact). This method includes the three processes of filling, orienting and sintering, which are performed in this order to create a sintered magnet. A brief description of this method is as follows: In the filling process, an alloy powder is supplied into a filling container (which is hereinafter called the “mold”), after which the density of the alloy powder in the mold is increased by a pushing, tapping or similar operation to a level of approximately 3M-4.2 g/cm³, which is higher than a natural filling density and lower than that of the press compact. In the orienting process, a magnetic field is applied to the alloy powder in the mold, without applying any pressure, to orient and align the crystal axes of the particles of the alloy powder in one direction. In the sintering process, the alloy powder which has been aligned in one direction in the orienting process is heated, together with the mold, to be sintered.

In the method of Patent Document 2, since no pressure is applied to the alloy powder in the magnetic orienting process and the density of the alloy powder is lower than that of the compact in the press-molding process, the friction among the particles of the alloy powder is reduced. Accordingly, in the orienting process, the powder particles can be aligned with high degree of orientation. As a result, an NdFeB magnet with even higher magnetic properties is obtained.

Patent Document 2 also discloses a system for producing a sintered magnet using an airtight container whose internal space can be maintained in an oxygen-free or inert-gas atmospheric condition, in which a filling unit, an orienting unit and a sintering unit are provided together with a conveyor for moving the filling container initially from the filling unit to the orienting unit and then from the orienting unit to the sintering unit. In this system, the alloy powder is handled under oxygen-free or inert-gas atmosphere throughout the entire process, so that the oxidization of the powder and the deterioration of magnetic properties due to the oxidization will not occur. Such a method in which no press compact is created, and in which the alloy powder is held in a mold until it is sintered into a magnet, will be hereinafter referred to as the “press-less process” or “PLP” method.

### BACKGROUND ART DOCUMENT

### Patent Document

Patent Document 1: JP-A S59-046008

Patent Document 2: JP-A 2006-019521

### SUMMARY OF THE INVENTION

### Problem to be Solved by the Invention

In recent years, expectations for slim-shaped sintered NdFeB magnets (with a small thickness in its direction of magnetization) that can be used at an ambient temperature of 100° C. or higher have been increasing. A typical example is the magnets for automobiles, whose market has begun to rapidly expand due to the necessity for addressing environmental problems or other reasons. However, the magnetic properties of sintered NdFeB magnets significantly deteriorate with an increase in the temperature. An irreversible demagnetization is likely to occur at an ambient temperature of 100° C. or higher.

To avoid this problem, it is necessary to produce a sintered NdFeB magnet having a coercive force H_{cJ} equal to or higher than a predetermined level, e.g. 15 kOe≈1.2 MA/m. (The coercive force H_{cJ} is the value of magnetic field H at which magnetization J becomes zero as the magnetic field H is decreased on the magnetization curve.) This is because a magnet with a high level of coercive force is difficult to be demagnetized and less likely to undergo irreversible demagnetization. A commonly used method for improving the coercive force of a sintered NdFeB magnet is to replace a portion of Nd with Dy and/or Tb.

However, this technique cannot be successfully applied to the method of Patent Document 2 since this method allows a relatively high degree of freedom of motion among the powder particles. For example, replacing a portion of Nd with Dy and/or Tb to improve the coercive force of the sintered NdFeB magnet also increases the coercive force of the individual particles of the alloy powder, causing a stronger magnetic interaction among the particles. Due to this magnetic interaction, the orientation of the crystal axes of the aligned particles become disturbed before the alloy powder is completely sintered, which lowers the degree of orientation of the sintered NdFeB magnet after the sintering process and decreases the residual magnetic flux density from the expected level computed from the alloy composition.

The decrease in the residual magnetic flux density is more noticeable in the case of a slim-shaped sintered NdFeB magnet. This is due to the fact that the decreased amount of the alloy powder in the magnetizing direction strengthens the demagnetizing field acting on the alloy powder during the orienting process, and this demagnetizing field tends to disturb the alignment of the powder particles.

Given such a problem, a conventional method for producing a sintered magnet includes the steps of creating a block-shaped sintered NdFeB magnet having an adequate thickness in the direction of magnetization and cutting the block into thin plates to obtain a product that meets the aforementioned demand. One problem with this method is the waste dust produced by the cutting process, which cannot be reused for magnets and therefore not only deteriorates the use efficiency of the material but also increases the production cost. Another problem is that the cutting process mechanically damages the product, causing a decrease in the squareness (H_{K}/H_{cJ}) of the demagnetization curve or other magnetic properties.

The problem to be solved by the present invention is to provide a method and system for inexpensively producing a slim-shaped sintered NdFeB magnet having excellent magnetic properties, such as the residual magnetic flux density and coercive force.

### Means for Solving the Problems

A number of experiments and studies conducted by the present inventors have revealed that heating the NdFeB alloy powder in the orienting process to decrease the coercive force of the individual particles of the alloy powder is effective for suppressing the disturbance of the alignment of a magnetically oriented alloy powder. This technique makes it possible to maintain the degree of orientation of the alloy powder and thereby prevents a decrease in the residual magnetic flux density of the sintered NdFeB magnet even when the coercive force of the individual particles of the alloy powder increases due to the mixture of Dy into the alloy powder or when a strong demagnetizing field is formed due to a reduced amount of alloy powder in the magnetizing direction.

That is to say, a method for producing a sintered NdFeB magnet according to the present invention aimed at solving the aforementioned problem includes a filling process for filling an NdFeB alloy powder into a mold to a density within a range from 3.0 to 4.2 g/cm³, an orienting process for orienting the alloy powder in the mold by a magnetic field, and a sintering process for sintering the oriented alloy powder together with the mold, and the method further includes a heating process for heating the alloy powder in the mold before and/or after the application of the orienting magnetic field in the orienting process.

The heating temperature in the heating process should preferably be equal to or higher than 50° C. and equal to or lower than 300° C. At temperatures lower than 50° C., the coercive force of the individual particles of the alloy powder will barely decrease, so that the aforementioned effect of improving the degree of orientation by decreasing the coercive force cannot be obtained. At temperatures higher than 300° C., the individual particles of the alloy powder will be completely demagnetized by heat, so that the alloy powder will no longer be oriented even when the orienting magnetic field is applied.

The content of Dy in the alloy powder should preferably be equal to or higher than 1 wt % and lower than 6 wt %. When the content of Dy is lower than 1 wt %, the produced sintered NdFeB magnet cannot have an adequately high level of coercive force. When the content of Dy is equal to or higher than 6 wt %, the magnetic properties of the produced sintered NdFeB magnet other than the coercive force will deteriorate and, additionally, the production cost will be too high. More preferably, the content of Dy should be equal to or higher than 1 wt % and lower than 5 wt %, and even more preferably equal to or higher than 1 wt % and equal to or lower than 4 wt %.

Thus, the inclusion of the heating process in the orienting process promotes the demagnetization of the individual particles of the alloy powder and suppresses the disturbance of the alignment of the alloy powder after the magnetic orientation process. The process of magnetically orienting the alloy powder after heating the same powder is hereinafter referred to as the “heating orientation.”

The heating orientation process does not completely demagnetize the entire amount of the alloy powder; although the heating process reduces the amount of deterioration in the degree of orientation, the residual magnetization still has the potential of disturbing the alignment of the crystal axes of the powder particles. The disturbance of the crystal axes is particularly noticeable in the surface regions where the particles are less bound by their mutual friction. As a result, the surface shape of the produced sintered magnet will be unstable. This is unfavorable for the “near-net-shape” molding (the capability of producing sintered magnets in a shape near the final product), which is one of the characteristics of the PLP method.

Another problem is that the molds containing the alloy powder attract or repel each other due to the residual magnetization, impeding the handling of the molds after the orienting process.

To solve the previously described problems, it is preferable to perform, at the end of the orienting process, a heating demagnetization process for applying a demagnetizing magnetic field to the alloy powder maintained in the heated state created by the heating process.

The orienting magnetic field for orienting the alloy powder is applied at a high strength of several T (tesla) so that the force of moving the particles will be adequately stronger than the frictional force among the particles. The demagnetizing magnetic field to be applied for demagnetizing the oriented alloy powder must at least exceed the coercive force of the powder particles. However, using an excessively strong demagnetizing field will disturb the directions of the crystal axes that have been aligned by the orienting magnetic field.

The ease of motion of powder particles depends on the frictional force among the particles. At a filling density used in the PLP method (from 3.0 to 4.2 g/cm³), it is possible to completely demagnetize the individual particles of the powder by applying a demagnetizing magnetic field having a strength of 480 kA/m (≈6 kOe) or less, without causing the situation that the demagnetizing magnetic field exceeds the frictional force among the particles and disturbs the directions of their crystal axes. A more preferable upper limit of the magnetic field strength is 240 kA/m (≈3 kOe). A strength value of 480 kA/m approximately corresponds to 0.6 T, and 240 kA/m approximately corresponds to 0.3 T. These values demonstrate that the demagnetizing magnetic field is much weaker than the orienting magnetic field, which has a strength of several T, as already explained.

The temperature of the alloy powder in the process of applying the demagnetizing magnetic field should preferably be equal to or higher than a temperature at which the coercive force of the powder particles is 120 kA/m (≈1.5 kOe). This is because, if the coercive force of the powder particles is higher than this level, the application of the demagnetizing magnetic field causes rotation of the individual particles of the powder, and ultimately disturbing their alignment.

The demagnetizing magnetic field may be a damped AC (alternating-current) magnetic field which is gradually damped from the aforementioned magnetic field strength as an initial (maximum) peak strength (an AC magnetic field whose amplitude gradually decreases with time to an adequately small value, which is normally zero) or a DC (direct-current) magnetic field applied opposite to the direction of magnetization of the alloy powder that has undergone the heating orientation at the aforementioned magnetic field strength.

A system for producing a sintered NdFeB magnet according to the present invention aimed at solving the previously described problems is a system including a filling system for filling an NdFeB alloy powder into a mold to a density within a range from 3.0 to 4.2 g/cm³, an orienting device for orienting the alloy powder in the mold, and a sintering device for sintering the oriented alloy powder together with the mold, wherein the orienting device includes:

a magnetic-field applying device for applying a magnetic field to the alloy powder; and

a heating device for heating the alloy powder in the mold before and/or after the magnetic-field applying device applies an orienting magnetic field to the alloy powder.

In one mode of the present invention, the system further includes a controller for controlling the heating device and the magnetic-field applying device so that, after the alloy powder has been subjected to heating orientation by the heating device and the magnetic-field applying device, a demagnetizing magnetic field is applied to the alloy powder maintained in the heated state.

### Effect of the Invention

In the method and system for producing a sintered NdFeB magnet according to the present invention, an alloy powder held in a mold is heated either before or after, or both before and after the alloy powder is oriented by an orienting magnetic field. This heat treatment prevents the disturbance of the alignment of alloy powder which has been magnetically oriented. The high degree of orientation is maintained throughout the sintering process of the alloy powder even when a predetermined amount of Dy is added to the alloy powder to increase the coercive force or when the amount of the alloy powder in the magnetizing direction is decreased in order to produce a slim-shaped sintered magnet. As a result, a slim-shaped sintered NdFeB magnet having high coercive force and high residual magnetic flux density can be inexpensively produced.

In the case where the process of applying a demagnetizing magnetic field to the alloy powder maintained in the heated state is provided after the orienting process, the residual magnetization is decreased to zero without affecting the orientation of the crystal axes of the previously aligned powder particles. As a result, the surface shape of the sintered magnet to be eventually obtained will be stabilized. Furthermore, the handling of the molds after the orienting process will be easier since the molds containing the alloy powder will not attract or repel each other.

### BRIEF DESCRIPTION OF THE DRAWINGS

FIG. 1 is a schematic vertical sectional view showing the configuration of a sintered magnet production system used in a conventional PLP method.

FIG. 2A is a model diagram showing the directions of the crystal axes of the individual particles of the alloy powder when a magnetic field is applied in the orienting process, FIG. 2B is a model diagram showing the directions of the crystal axes after the magnetic field is removed, and FIG. 2C is a model diagram showing magnetic domains formed after the heating orientation.

FIG. 3 is a graph showing a change in the degree of orientation and the coercive force with respect to the content of Dy in the alloy composition.

FIG. 4 is a graph showing the relationship between the measured temperature of the mold and the coercive force under the condition that the content of Dy is 4.1 wt % or 7.5 wt&.

FIG. 5 is a schematic vertical sectional view showing one embodiment of the system for producing a sintered NdFeB magnet according to the present invention.

FIGS. 6A and 6B are model diagrams showing the process steps in the orienting unit of the system for producing a sintered NdFeB magnet according to the present embodiment.

FIG. 7 is a diagram showing the waveforms of electric currents passed through a magnetic-field applying coil in the orienting unit.

FIG. 8 is a graph showing the relationship between the temperature change of the mold and the cooling time after the mold is heated to 250° C.

FIGS. 9A and 9B are a top view (FIG. 9A) and vertical sectional view (FIG. 9B) of one example of the shape of the mold used in the system for producing a sintered NdFeB magnet according to the present embodiment.

FIGS. 10A and 10B are a top view (FIG. 10A) and vertical sectional view (FIG. 10B) of another example of the shape of the mold used in the system for producing a sintered NdFeB magnet according to the present embodiment.

FIGS. 11A and 11B are a top view (FIG. 11A) and vertical sectional view (FIG. 11B) of still another example of the shape of the mold used in the system for producing a sintered NdFeB magnet according to the present embodiment.

FIG. 12 is a block diagram showing the configuration of the orienting unit in one variation of the system for producing a sintered NdFeB magnet according to the present embodiment.

FIG. 13 is a model diagram showing the steps of operations in the orienting unit of the system for producing a sintered NdFeB magnet according to the present variation.

FIG. 14 is a graph showing the temperature-dependency of the coercive force of the particles of alloy powders.

### BEST MODE FOR CARRYING OUT THE INVENTION

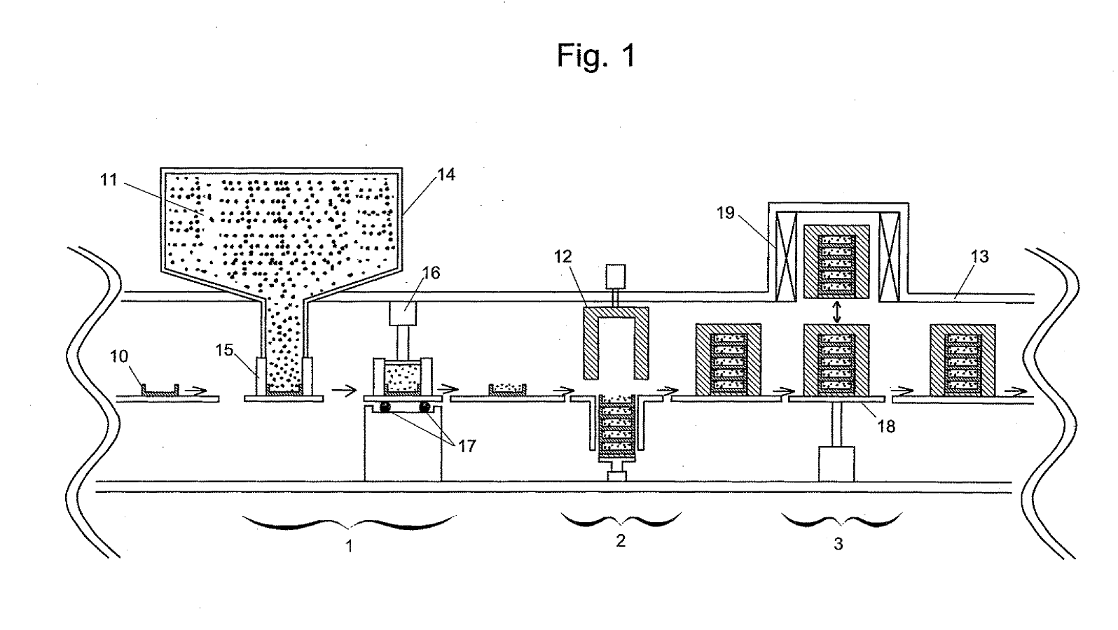

A general configuration of a sintered magnet production system used in the conventional PLP method is shown in the vertical sectional view of FIG. 1. The sintered magnet production system shown in FIG. 1 includes; a filling unit 1 for supplying an alloy powder 11 into a mold 10 and increasing its density to a level of 3.0-4.2 g/cm³; a containing unit 2 for receiving a stack of molds 10 holding the alloy powder 11 and for setting the molds 10 in a mold container 12; an orienting unit 3 for orienting, within a magnetic field, the alloy powder 11 held in the molds 10 in the mold container 12; a sintering furnace (not shown) for sintering the alloy powder 11 together with the molds 10 and the mold container 12 after the powder is oriented by the orienting unit 3; and a conveying unit, consisting of a belt conveyor and a manipulator (not shown), for conveying the molds 10 or mold container 12 to any of the aforementioned units or the sintering furnace. The filling unit 1, containing unit 2, orienting unit 3 and conveying unit 4 are included in an airtight container 13 so that sintered magnets can be produced under an oxygen-free or inert-gas (e.g. Ar) atmosphere. The internal space of the sintering furnace (not shown) communicates with this airtight container 13. Accordingly, similar to the airtight container 13, the inside of the furnace can also be maintained in an oxygen-free or inert-gas atmospheric condition. A heat-insulating door is provided between the sintering furnace and the airtight container 13. During the sintering process, this door is closed to prevent a temperature increase within the airtight container 13.

An operation of the sintered magnet production system of FIG. 1 is hereinafter described.

In the filling unit 1, after a mold 10 is placed directly below the supply port of a hopper 14, a predetermined amount of alloy powder 11 is supplied into the mold 10. At this point, the bulk density of the powder is low since the filling density of the powder is close to the natural filling density. Accordingly, a guide 15 is attached to the mold 10 so that the predetermined amount of alloy powder 11 can be supplied into the mold 10. Subsequently, this mold 10, with the guide 15 attached thereto, is moved to a position under a pusher 16, which applies pressure from above. The pressure from this pusher 16 only needs to be at a level of approximately 15 kgf/cm² MPa) or may be even lower. Simultaneously with the application of the pressure from the pusher 16, a tapping device 17 supporting the mold 10 from below begins to slightly vibrate the mold 10. This operation causes the alloy powder 11 to be evenly filled into the mold 10 at a predetermined density, while pressing the alloy powder in the mold 10 down to the level of the upper end of the container. Subsequently, the guide 15 is removed from the mold 10.

The filling density of the powder in the mold should preferably be within a range from 3.0 to 4.2 g/cm³. If the filling density is lower than this range, the sintering of the powder may possibly be insufficient, failing to achieve the required density. Conversely, if the filling density exceeds 4.2 g/cm³, the friction among the powder particles will be too strong to achieve a high degree of orientation. A preferable range of the filling density is from 3.5 to 4.0 g/cm³, and more preferably from 3.6 to 4.0 g/cm³.

The mold 10 holding the alloy powder 11 is conveyed to the containing unit 2 by the belt conveyor. In the conveying unit 2, a plurality of molds 10 are stacked by the manipulator and loaded into the mold container 12. Each of the molds 10 contained in the mold container 12 has its upper side covered with either the bottom of another mold 10 located immediately above or the mold container 12. Thus, the alloy powder 11 is prevented from being scattered during the orienting process in the orienting unit 3. Furthermore, the simultaneous production of a plurality of sintered magnets improves the working efficiency.

After a plurality of molds 10 are loaded into the mold container 12, the mold container 12 is transferred onto a lift 18. Then, the lift 1.8 is moved upward, whereby the mold container 12 on the lift 18 is inserted into a magnetic-field applying coil 19. Subsequently, a DC or AC current is passed through the coil 19 to generate a DC or AC magnetic field, whereby the alloy powder 11 in each of the molds 10 contained in the mold container 12 is oriented in the axial direction of the coil 19. The thereby applied magnetic field should preferably be a pulsed magnetic field. This pulsed magnetic field should be as strong as possible; its strength should be at least 3T, and preferably 5T or higher. Using a pulsed magnetic field weaker than 3T prevents the degree of orientation from reaching a desired level. Combining an AC magnetic field and a DC magnetic field as the aforementioned magnetic field is particularly effective. There are many possible combinations of magnetic fields. Typical examples of the patterns for applying magnetic fields are: consecutive application of an AC magnetic field and a DC magnetic field, consecutive application of one AC magnetic field and another AC magnetic field, and consecutive application of an AC magnetic field, another AC magnetic field and a DC magnetic field in this order. After the crystal axes of the alloy powder 11 have been aligned by the magnetic field, the lift 18 is lowered.

At the last stage, the mold container 12 is transferred into the sintering furnace, where the alloy powder 11 with the crystal axes in the aligned state are heated, together with the mold 10 and the mold container 12, to a temperature of 950° to 1050° C. to sinter the alloy powder 11. Subsequently, the powder is subjected to an additional heat treatment at 900° C. or lower temperature. Thus, sintered magnets are completed.

In the PLP method, as compared to the method using a pressing machine, the friction among the particles of the alloy powder is reduced. Accordingly, the particles of the alloy powder can be aligned with a higher degree of orientation in the orienting process. Therefore, the produced sintered magnets have better magnetic properties than those produced by using a pressing machine.

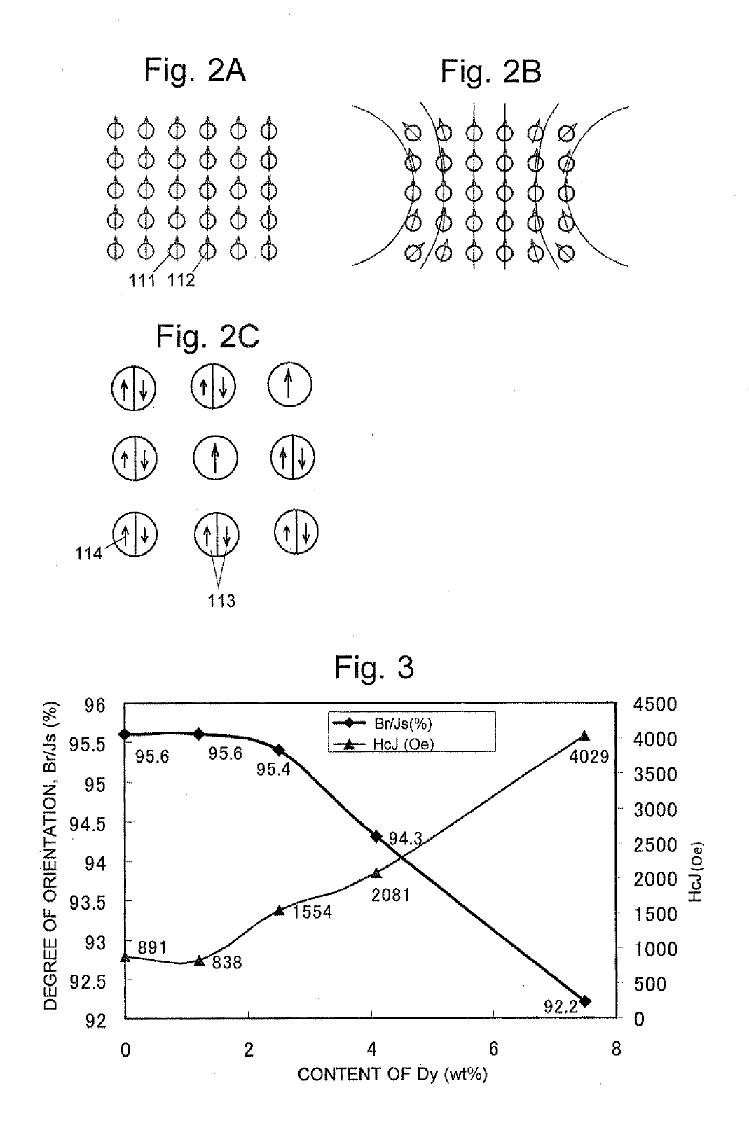

However, when the coercive force of the individual particles of the alloy powder is increased, the magnetic interaction among the powder particles after the removal of the applied magnetic field increases. Therefore, even if a high degree of orientation is achieved in the orienting process, the degree of orientation decreases before the sintering process. The principle of this phenomenon is hereinafter explained by means of FIGS. 2A-2C. In these figures, each particle 111 of the alloy powder sphere is represented by one sphere, with the crystal axis being oriented in the direction of the arrow 112. As shown in FIG. 2A, when a strong magnetic field is applied, the direction 112 of the crystal axis of each powder particle 11 is aligned with the direction of the applied magnetic field. However, if the particles of the alloy powder have a high coercive force, a significant amount of influence of the magnetization remains even after the magnetic field is removed, causing the directions of the crystal axes 112 to be disturbed due to the magnetic interaction between the neighboring particles, as shown in FIG. 2B. The disturbance of the alignment becomes more noticeable as the permeance coefficient decreases. (A permeance coefficient is an index of the thickness in the orientation direction. A smaller permeance coefficient represents a smaller thickness in the orientation direction and a stronger demagnetizing field.) This is because a stronger demagnetizing field acts on the individual particles of the alloy powder, exerting a stronger disturbing force on the oriented particles. Conversely, if the particles of the alloy powder have a low coercive force, when the magnetic field is removed, a plurality of magnetic domains 114 having mutually opposite magnetization directions 113 are created inside each powder particle, as shown in FIG. 2C, due to the magnetic field or demagnetizing field from the neighboring particles. Thus, the amount of magnetization of each particle is decreased (i.e. each particle is demagnetized) while maintaining the direction 112 of the crystal axis in the aligned state. In this manner, the deterioration in the degree of orientation is alleviated.

FIG. 3 is a graph demonstrating the relationship between the content of Dy in the alloy powder and the degree of orientation as well as the coercive force of the powder particles. The experimental data shown in FIG. 3 were obtained for the alloy compositions shown in Table 1.

TABLE 1

| Alloy No. | Dy | Nd | Pr | Co | Cu | B | Al | Fe |
|---|---|---|---|---|---|---|---|---|
| 1 | 0.03 | 26.6 | 4.7 | 0.92 | 0.09 | 1.01 | 0.27 | bal. |
| 2 | 1.2 | 23.3 | 6.9 | 0.91 | 0.09 | 0.99 | 0.23 | bal. |
| 3 | 2.5 | 23.5 | 5.2 | 0.92 | 0.09 | 0.98 | 0.28 | bal. |
| 4 | 4.1 | 21.6 | 6.1 | 0.90 | 0.10 | 1.00 | 0.20 | bal. |
| 5 | 7.5 | 18.8 | 4.7 | 0.98 | 0.12 | 0.94 | 0.17 | bal. |

Note:
The values are shown in units of wt %.

As shown in FIG. 3, the content of Dy in the alloy powder significantly affects the coercive force of the powder particles. When the Dy content was within a range from 0 to approximately 1.2 wt %, the coercive force was at around 0.8 kOe. As the Dy content further increased, the coercive force rapidly increased, exceeding the level of 4 kOe at a Dy content of 7.5 wt %. Meanwhile, with the increase in the Dy content, the degree of orientation of the magnet produced by the conventional PLP method decreased from 95.5% to 92.5%. It should be noted that the measured result shown in FIG. 3 was obtained for a magnet of 8 mm in diameter and 8 mm in the height in the orientation direction with a permeance coefficient of approximately 3.3. The deterioration in the degree of orientation with the increase in the Dy content will be more noticeable if the permeance coefficient is further decreased.

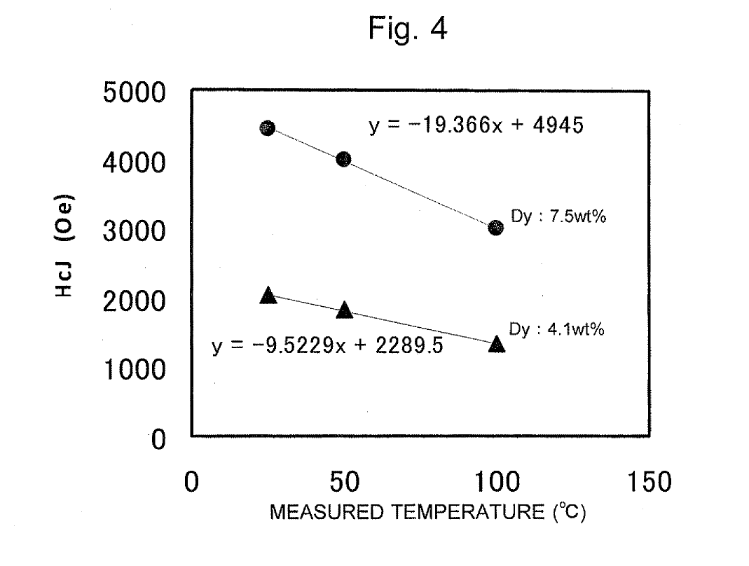

For the previously described problem, the present inventors have discovered that the disturbance of the alignment of magnetically oriented alloy powder can be suppressed by increasing the temperature of the alloy powder by heating this powder together with the mold containing it. This method is hereinafter explained by means of FIG. 4. FIG. 4 is a graph showing the relationship between the measured temperature of the mold and the coercive force of the powder particles. The temperature of the mold was measured on its outer circumference with a laser thermometer. The alloy powders used in the measurement had the same compositions as two samples with Dy contents of 4.1 wt % (Alloy No. 1) and 7.5 wt % (Alloy No. 5) shown in Table 1. The graph demonstrates that the coercive force of the alloy powder rapidly decreases as the temperature increases. A decrease in the coercive force of the alloy powder means that the powder is more easily demagnetized when a demagnetizing magnetic field is applied to it. Accordingly, how to create this situation in the actual production process is the key to the problem.

### Embodiment

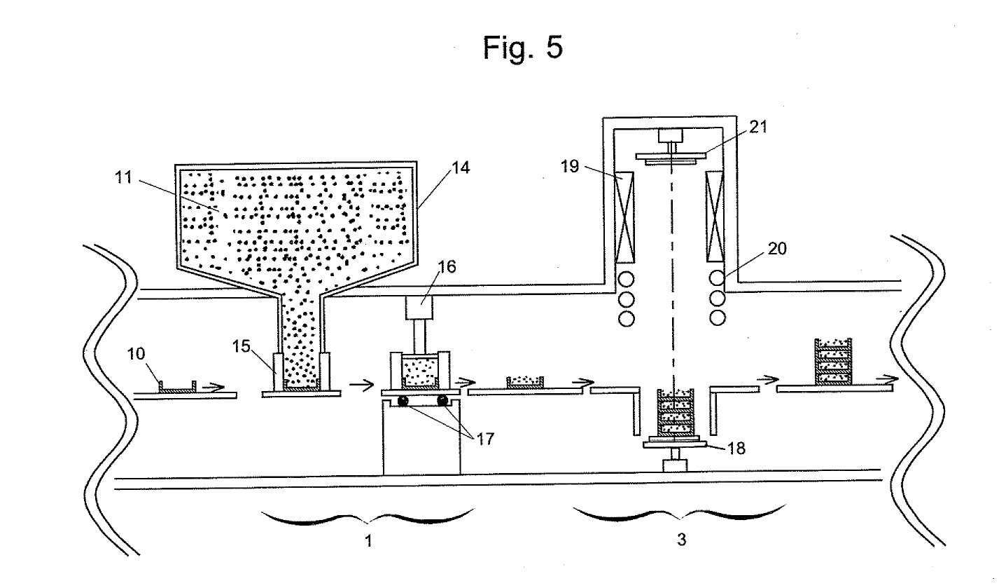

The first embodiment of the system for producing a sintered NdFeB magnet according to the present invention is hereinafter described by means of FIGS. 5, 6A and 61B Although the basic configuration of this system is similar to the one shown in FIG. 1, a difference exists in that an induction heating coil 20 for heating the alloy powder together with the molds 10 is provided in the orienting unit 3. In the system for producing a sintered magnet according to the present embodiment, the molds 10 are inserted into the induction heating coil 20, and electric current is passed through the induction heating coil 20 to heat the alloy powder 11 together with the mold 10. The induction heating coil 20 is arranged over the conveyor line in such a manner that its central axis is aligned with that of the magnetic-field applying coil 19. Accordingly, the heating process and the magnetic-field applying process can be consecutively performed by vertically moving the lift 18.

The heating method is not limited to induction heating; there are many other possible choices, such as electrical resistance heating or laser-irradiation heating. Any type of heating method may be used as long as the temperature of the molds holding the alloy powder can be evenly increased to a predetermined level within a predetermined period of time and the heater can be installed in an inert-gas atmosphere in which the PLP method is performed.

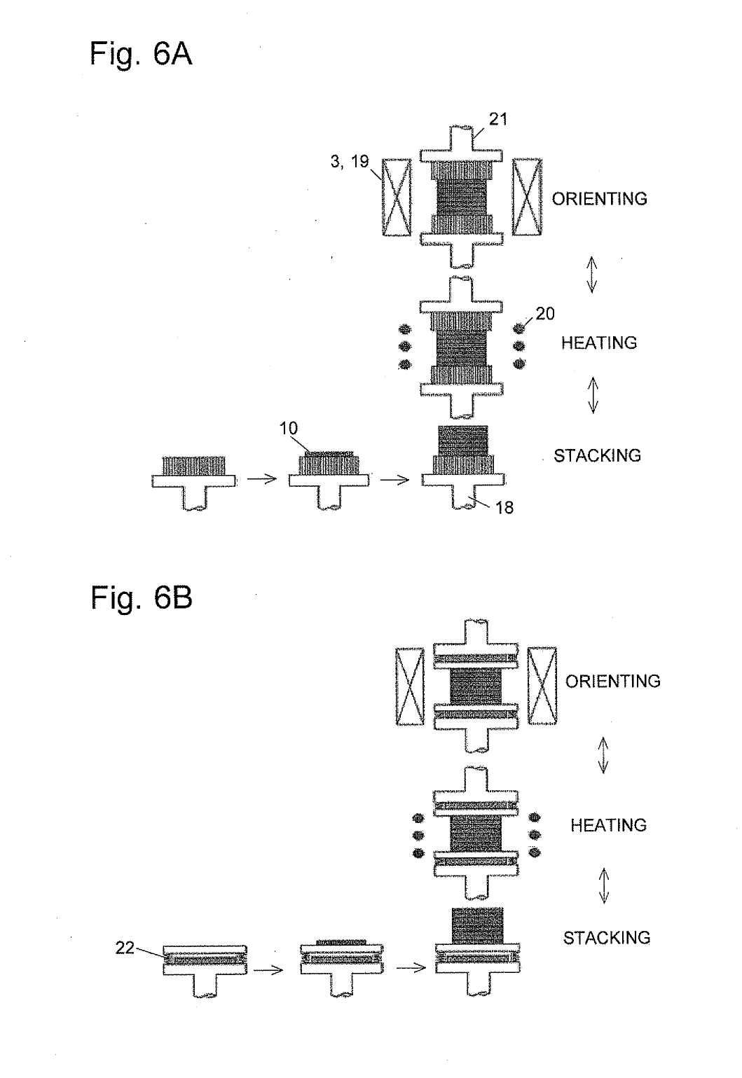

In the present embodiment, the molds 10 are not contained in the mold-container 12 so that the molds 10 and the alloy powder 11 contained therein can be easily heated by the induction heating coil 20. Accordingly, the system of the present embodiment has no containing unit 2; the stacking of the molds 10 is performed on the lift 18. The absence of the mold container 12 means that no cover is put on the top of the stack of the molds 10. To prevent the scattering of the alloy powder 11 from the top of the stack of the molds 10 during the heating and orienting processes, a fixing base 21 composed of an air cylinder, a lid and other components for pressing the stacked molds 10 from above is provided in the upper portion of the orienting unit 3. The fixing base 21 should preferably be made of a magnetic material whose permeability and saturation magnetization are comparable to those of the alloy powder. Examples of such materials include a magnetic steel sheet, a SmCo magnet, a powder magnetic core, and a laminate of Fe graphite sheets. Using any of these materials has the effect of aligning the directions of the lines of the magnetic field perpendicularly applied to the molds 10. Furthermore, as shown in FIG. 6B, a spring 22 may be provided in both the lift 18 and the fixing base 21 to prevent an excessive pressure from being applied to the stacked molds 10.

An operation of the system for producing a sintered NdFeB magnet according to the present embodiment is hereinafter described. The operation of the system for producing a sintered NdFeB magnet according to the present embodiment is the same as that of the sintered magnet production system using the conventional PLP method shown in FIG. 1, except for the use of an NdFeB alloy powder as the alloy powder 11, the absence of the containing unit 2, and the operation of the orienting unit 3. Accordingly, the following description is focused solely on the operation in the orienting unit 3.

In the system for producing a sintered NdFeB magnet according to the present embodiment, the stacking of the molds 10 is performed on the lift 18. After a predetermined number of molds 10 have been stacked on the lift 18, the fixing base 21 is lowered to hold the molds 10 from above and below by the fixing base 21 and the lift 18. Therefore, for example, in the magnetic orientation process, the molds 10 are prevented from moving and the alloy powder 11 in the molds 10 is prevented from being scattered. After being held by the lift 18 and the fixing base 21, the molds 10 are moved into the magnetic-field applying coil 19, where an AC magnetic field is initially applied. After the application of the AC magnetic field is completed, the molds 10 are lowered to the level of the induction heating coil 20, where the molds 10 and the alloy powder 11 held therein are heated to a predetermined temperature. After this heating process, the molds 10 are once more moved into the magnetic-field applying coil 19, where, this time, a DC magnetic field is applied. After the application of the DC magnetic field is completed, the molds 10 are conveyed to the sintering furnace and sintered.

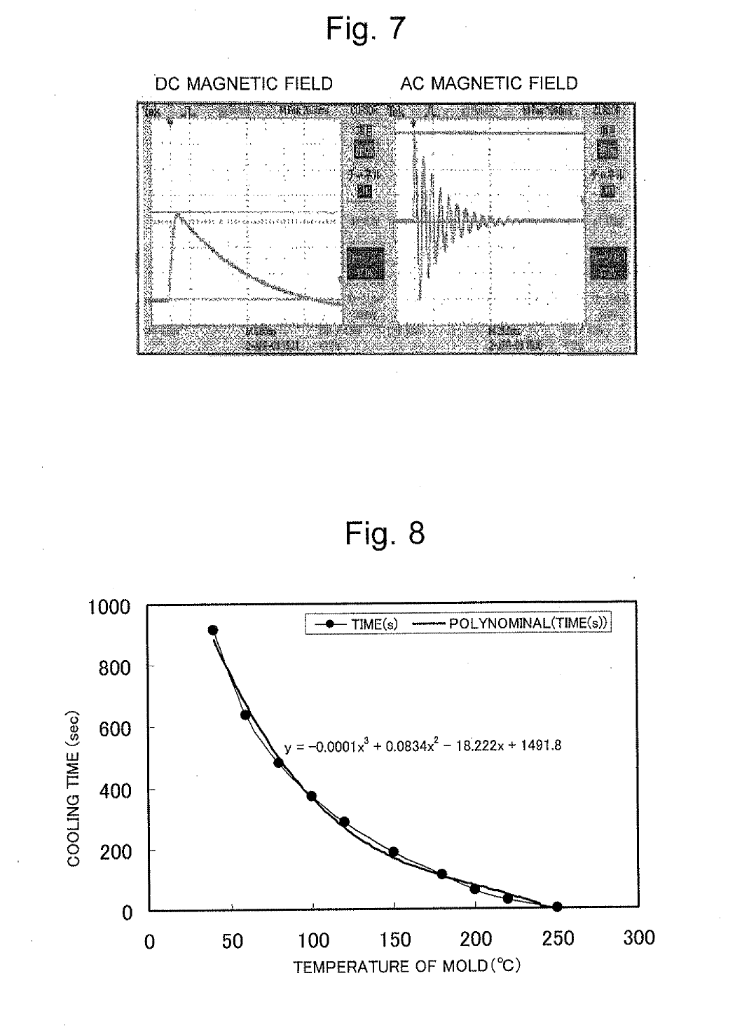

The combination of AC and DC magnetic fields applied by the system for producing a sintered NdFeB magnet according to the present embodiment may be different from the previous example. Each of the applied magnetic fields should preferably be a pulsed magnetic field with a strength of 3 T or higher, and more preferably 5 T or higher, as in the case of the conventional PLP method. FIG. 7 shows the waveforms of electric currents respectively passed through a magnetic-field applying coil 19 when a DC or AC magnetic field is applied. Each of these waveforms is a waveform of an electric current which flows through the magnetic-field applying coil 19 when a capacitor (5000 μF) of a power source is charged by a voltage of 6000 V and then discharged. The strength of the magnetic field at the maximum peak of the waveform is 5.75 T in both of the pulsed DC and AC magnetic fields. To consecutively apply these magnetic fields in the orienting process, the next electric current should be applied after the current waveform as shown in FIG. 7 has been sufficiently damped.

The average particle size of the alloy powder should be as small as possible, since a smaller particle size leads to a higher coercive force. However, if the particle size of the powder is too small, the coercive force rather deteriorates due to oxidation of the powder particles. In view of this problem, the average particle size of the alloy powder should preferably be equal to or larger than 1 μm and equal to or smaller than 5 μm, and more preferably equal to or larger than 1 μm and equal to or smaller than 3.5 μm.

The heating of the alloy powder 11 in the molds 10 cannot be simultaneously performed with the orienting process. Accordingly, to achieve a desired temperature of the mold 10 (or the alloy powder 11) in the magnetic orientation process, the temperature to be achieved by induction heating must be set at a slightly higher level, taking into account a decrease in the temperature during the movement of the molds 10 from the induction heating coil 20 to the magnetic-field applying coil 19.

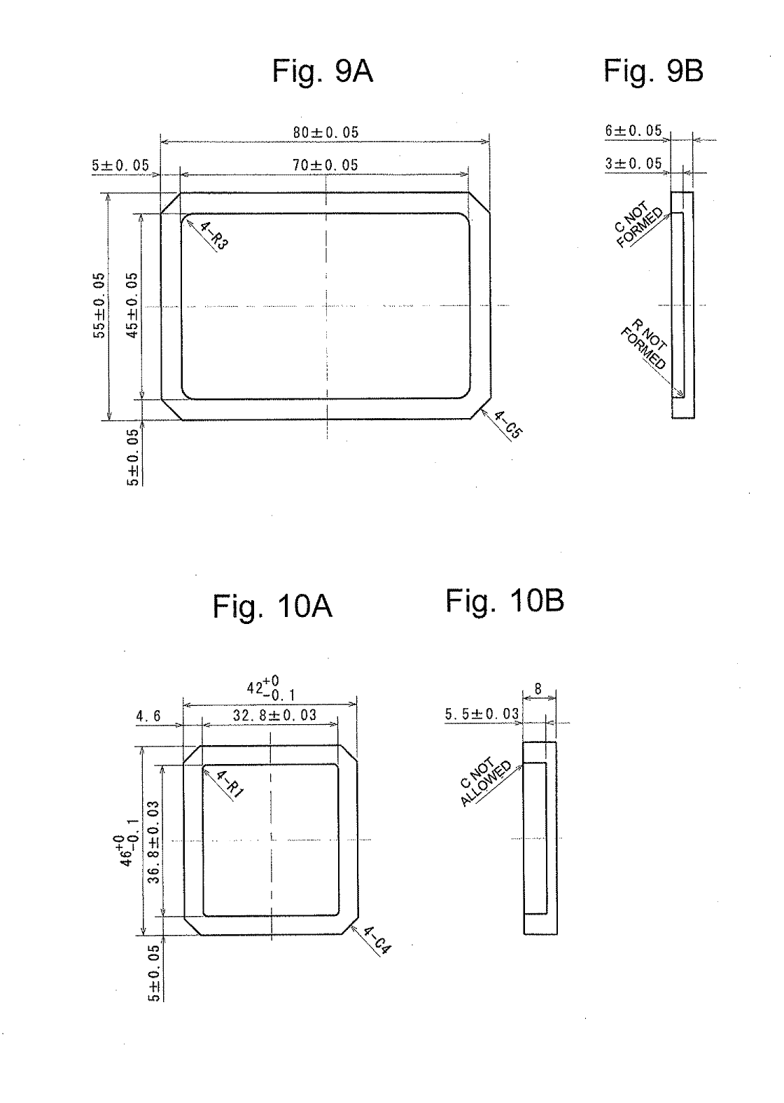

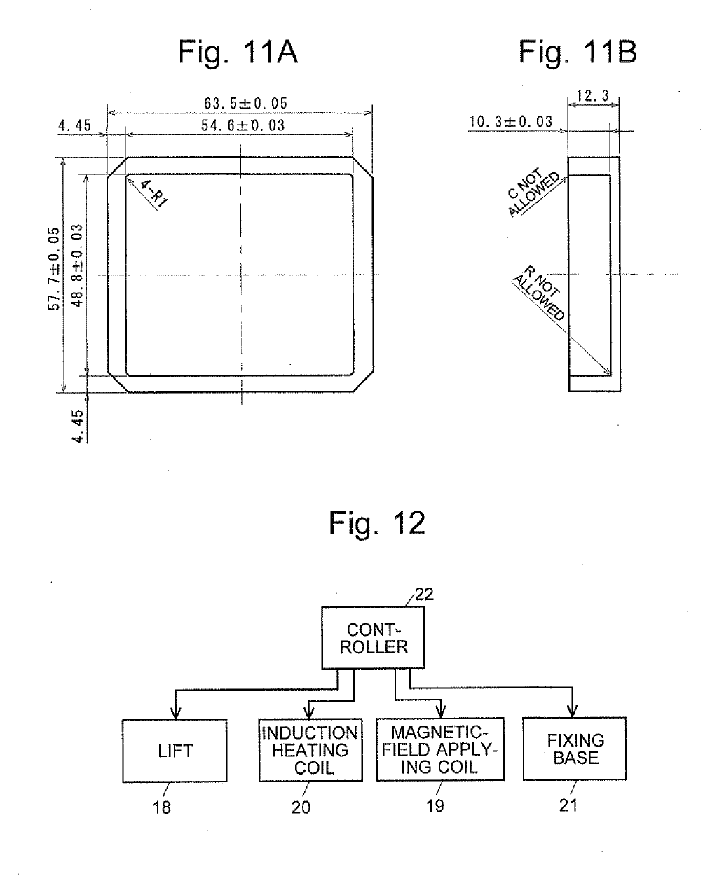

FIG. 8 shows the relationship between the temperature of the mold and the cooling time in the case where four molds shown in FIGS. 9A and 9B were stacked, each mold holding 34 g of alloy powder at a filling density of 3.6 g/cm³. For example, the graph of FIG. 8 demonstrates that, when the temperature of the mold for the magnetic orientation process is 200° C., the target temperature can be achieved by de-energizing the heating device when the temperature has reached to 250° C., and 60 seconds later, applying the magnetic field. Such a relationship between the temperature of the mold and the cooling time can be easily determined, for example, by a preliminary experiment. By using such data obtained by preliminary experiments or other methods, the magnetic orientation process can be performed at a desired temperature when the sintered magnet is produced under various conditions, e.g. when a different mold as shown in FIGS. 10A and 10B or FIGS. 11A and 11B is used or the composition and/or filling density of the alloy powder is changed.

The timing of heating the mold and applying the magnetic field can be arbitrarily set on a case-by-case basis according to the composition of the alloy powder. For example, when the applications of the magnetic fields in the orienting process are performed in the order of AC and DC magnetic fields, the heating process can be performed between the applications of AC and DC magnetic fields. There are many other possible methods, such as heating the mold before the application of the AC magnetic field, before the application of the AC magnetic field as well as immediately after the application of the DC magnetic field, or before the application of the AC magnetic field as well as before the application of the DC magnetic field. The heating temperature should also be appropriately set. For example, for the alloy powder having a Dy content of 4.1 wt % in FIG. 4, the heating temperature should preferably be set so that the temperature of the mold will be approximately 160° C. when the magnetic field is applied after the heating process. This is because, from the interpolation line in FIG. 4, the coercive force of the aforementioned alloy powder corresponding to 160° C. is expected to be approximately 0.8 kOe (≈64 kA/m), and under this condition, the sintered NdFeB magnet can be produced in roughly the same manner as in the case of the Dy content of zero shown in FIG. 3. It is also possible to heat the mold after applying the DC magnetic field and before initiating the sintering process. In this case, for example, setting the heating temperature at approximately 300° C. causes the particles of the alloy powder to be completely demagnetized by heat until the sintering process. This method is very effective since it prevents the disturbance of the alignment of the particles of the alloy powder after the orienting process.

The magnetic properties of various samples of the sintered NdFeB magnets produced by the system according to the present embodiment are hereinafter presented.

In the first experiment, an alloy powder with a Dy content of 4.1 wt % (Alloy No. 4 in Table 1) was filled into a mold shown in FIGS. 9A and 9B at a filling density of 3.6 g/cm³. Four molds prepared in this manner were stacked and subjected to heating and magnetic orientation processes in the order as shown in Table 2, and subsequently sintered at 1030° C. The magnetic properties of the sintered NdFeB magnets thus produced were as shown in Table 3.

TABLE 2

| | Induction | | Induction | | Induction | | Induction |
|---|---|---|---|---|---|---|---|
| | Heating | AC | Heating | AC | Heating | DC | Heating |
| Example 1 | — | Room | — | Room | 250° C. | 200° C. | — |
| Example 2 | | Temperature | | Temperature | | | 300° C. |
| Comparative | | | | | — | Room | — |
| Example 1 | | | | | | Temperature | |
| Comparative | 250° C. | 200° C. | 250° C. | 200° C. | 250° C. | 200° C. | — |
| Example 2 | | | | | | | |
| Comparative | | | | | | | 300° C. |
| Example 3 | | | | | | | |

TABLE 3

| Sample | Br | Js | HcB | Hcj | BHMax | Br/Js | Hk | SQ |
|---|---|---|---|---|---|---|---|---|
| Name | (G) | (G) | (Oe) | (Oe) | (MGOe) | (%) | (Oe) | (%) |
| Example 1 | 12961 | 13630 | 12547 | 21935 | 41.20 | 95.1 | 17095 | 81.6 |
| Example 2 | 12862 | 13482 | 12459 | 21881 | 40.54 | 95.4 | 17932 | 82.0 |
| Comparative | 12430 | 13486 | 11683 | 18444 | 36.53 | 92.2 | 15502 | 84.1 |
| Example 1 | | | | | | | | |
| Comparative | 8640 | 12691 | 7903 | 24787 | 17.18 | 68.1 | 9093 | 36.7 |
| Example 2 | | | | | | | | |
| Comparative | 8734 | 12870 | 7991 | 24557 | 17.69 | 67.9 | 9229 | 37.6 |
| Example 3 | | | | | | | | |

In Table 3, Bᵣ is the residual magnetic flux density (the magnitude of magnetization or magnetic flux density B at the point where magnetic field H is zero on the magnetization curve (J-H curve) or demagnetization curve (B-H curve)), Jₛ is the saturation magnetization (the maximum value of magnetization J), H_{cB} is the coercive force of the demagnetization curve, H_{cJ} is the coercive force of the magnetization curve, (BH)_{Max} is the maximum energy product (the maximum value of the product of magnetic flux density B and magnetic field H on the demagnetization curve), Bᵣ/Jₛ is the degree of orientation, H_{K} is the value of magnetic field H at the point where magnetization J equals 90% of residual magnetic flux density Bᵣ, and SQ is the squareness (H_{K}/H_{cJ}). The larger these values are, the better the magnet properties are. All the sintered NdFeB magnets in the “as-sintered” state had a shape of 38 mm in width, 60 mm in height and 2 mm in the thickness in the orientation direction, with a permeance coefficient of approximately 0.1. The “as-sintered” state means that “the magnet has not undergone any machine work, such as grinding or cutting, and therefore maintains the same state since its removal from the sintering furnace.”

Table 3 demonstrates that the sintered magnets produced by the methods of Examples 1 and 2 yielded the best results for almost all the magnetic properties. In Examples 1 and 2, the heating process was not performed before the application of the AC magnetic field but before the application of the DC magnetic field or before and after it. The improvements in the magnet properties due to the introduction of the heating process were evident when compared to the results obtained in Comparative Example 1, in which the temperature was constantly maintained at room temperature. It was also found that, under the conditions used in the present experiment, the degree of orientation would rather deteriorate when the heating process was performed before the application of the AC magnetic field (Comparative Examples 2 and 3).

In the second experiment, the heating process was performed before the application of the DC magnetic field under the conditions shown in Table 4. As a result, the magnet properties changed as shown in Table 5.

TABLE 4

| | | | Induction Heating | | | |
|---|---|---|---|---|---|---|
| | | | Heating | | | |
| | | | Tem- | Heating | Current | |
| | AC | AC | perature | Time | Value | DC |
| Example 3 | Room | Room | 180° C. | 120 sec. | 150 A | 150° C. |
| Comparative | Tem- | Tem- | | 60 sec. | 200 A | |
| Example 4 | perature | perature | | | | |
| Comparative | | | 250° C. | 180 sec. | 150 A | 200° C. |
| Example 5 | | | | | | |

TABLE 5

| Sample | Br | Js | HcB | Hcj | BHMax | Br/Js | Hk | SQ |
|---|---|---|---|---|---|---|---|---|
| Name | (G) | (G) | (Oe) | (Oe) | (MGOe) | (%) | (Oe) | (%) |
| Example 3 | 13093 | 13715 | 12385 | 17244 | 40.83 | 95.5 | 15444 | 89.6 |
| Comparative | 12825 | 13572 | 12119 | 17770 | 39.14 | 94.5 | 15737 | 88.6 |
| Example 4 | | | | | | | | |
| Comparative | 12719 | 13532 | 12007 | 17852 | 38.44 | 94 | 15671 | 87.8 |
| Example 5 | | | | | | | | |

Table 5 demonstrates that the degree of orientation deteriorated when the heating temperature was 200° C., or when the heating temperature was 150° C. and the heating time was the shorter period of 60 seconds (Comparative Examples 4 and 5). A probable reason for the deterioration in the degree of orientation in the case of a high heating temperature is that increasing the temperature causes a reduction in the magnetic anisotropy of the alloy powder, which compromises the orienting effect of the applied magnetic fields. A probable reason for the deterioration in the degree of orientation in the case of a short heating time is that the temperature distribution of the alloy powder inside the mold becomes significantly varied, so that the demagnetizing effect due to the temperature increase occurs only in limited portions of the alloy powder, leaving the other portions at lower temperatures. By contrast, the results obtained in Example 3 were comparable to Examples 1 and 2. The degree of orientation exceeded 95%, and the other magnetic properties also improved.

In the third experiment, an alloy powder with a Dy content of 1.2 wt % (Alloy No. 2 in Table 1) was filled into a mold shown in FIGS. 10A and 10B at a filling density of 3.6 g/cm³. Four molds prepared in this manner were stacked and subjected to heating and magnetic orientation processes in the order as shown in Table 6, and subsequently sintered at 1030° C. The magnetic properties of the sintered NdFeB magnets thus produced were as shown in Table 7.

TABLE 6

| | | | Induction Heating | | |
|---|---|---|---|---|---|
| | | | Heating | | |
| | | | Temper- | Heating | |
| | AC | AC | ature | Time | DC |
| Example 4 | Room | Room | 180° C. | 76 sec. | 150° C. |
| Comparative | Temper- | Temper- | — | — | Room |
| Example 6 | ature | ature | | | Temper- |
| | | | | | ature |

TABLE 7

| Sample | Br | Js | HcB | Hcj | BHMax | Br/Js | Hk | SQ |
|---|---|---|---|---|---|---|---|---|
| Name | (G) | (G) | (Oe) | (Oe) | (MGOe) | (%) | (Oe) | (%) |
| Example 4 | 13906 | 14556 | 12521 | 14013 | 46.07 | 95.5 | 12539 | 89.5 |
| Comparative | 13517 | 14420 | 12570 | 14507 | 43.17 | 93.7 | 13444 | 92.7 |
| Example 6 | | | | | | | | |

The sintered NdFeB magnets produced by using the mold shown in FIGS. 10A and 10B, in their “as-sintered” state, had a shape of 32 mm in length, 28 mm in width and 3.7 mm in the thickness in the orientation direction, with a permeance coefficient of approximately 0.3. Table 7 demonstrates that, even when the Dy content is as low as 1.2 wt % and a permeance coefficient is approximately 0.3, the degree of orientation and the residual magnetic flux density will deteriorate if the magnetic orientation process is performed only at room temperature.

In the fourth experiment, an alloy powder with a Dy content of 2.5 wt % (Alloy No. 3 in Table 1) was filled into a mold shown in FIGS. 11A and 11B at a filling density of 3.6 g/cm³. Four molds prepared in this manner were stacked and subjected to heating and magnetic orientation processes in the order as shown in Table 6, and subsequently sintered at 1030° C. The magnetic properties of the sintered NdFeB magnets thus produced were as shown in Table 8.

TABLE 8

| Sample | Br | Js | HcB | Hcj | BHMax | Br/Js | Hk | SQ |
|---|---|---|---|---|---|---|---|---|
| Name | (G) | (G) | (Oe) | (Oe) | (MGOe) | (%) | (Oe) | (%) |
| Example 5 | 12918 | 13671 | 12393 | 19205 | 40.01 | 95.1 | 17419 | 90.7 |
| Comparative | 12512 | 13479 | 11974 | 20916 | 37.5 | 92.8 | 17902 | 85.6 |
| Example 7 | | | | | | | | |

The sintered NdFeB magnets produced by using the mold shown in FIGS. 11A and 11B, in their “as-sintered” state, had a shape of 45 mm in length, 40 mm in width and 7 mm in the thickness in the orientation direction, with a permeance coefficient of approximately 0.4. Table 8 demonstrates that the sintered NdFeB magnet obtained in Example 5 had higher magnetic properties than the magnet obtained in Comparative Example 7. From the results described thus far, it is evident that the production method including the heating process is effective.

In the previously described production method, the particles of the alloy powder are demagnetized by the heating orientation process, whereby a higher degree of orientation after the orienting process is achieved and the magnetic properties of the sintered magnet are improved. However, if the coercive force is decreased by only the heating process, a portion of the particles remain without any magnetic domain formed, as shown in FIG. 2C. This residual magnetization destabilizes the surface shape of the sintered magnet or impedes the handling of molds after the orienting process.

For this problem, the present inventors have discovered that the magnetization of the individual particles of alloy powder can be decreased to zero (i.e. completely demagnetized), without lowering the degree of orientation, by applying a predetermined magnetic field to those particles after decreasing their coercive force by heat. The process of demagnetizing the individual particles of alloy powder by applying a demagnetizing magnetic field after heating is hereinafter referred to as the “heating demagnetization.”

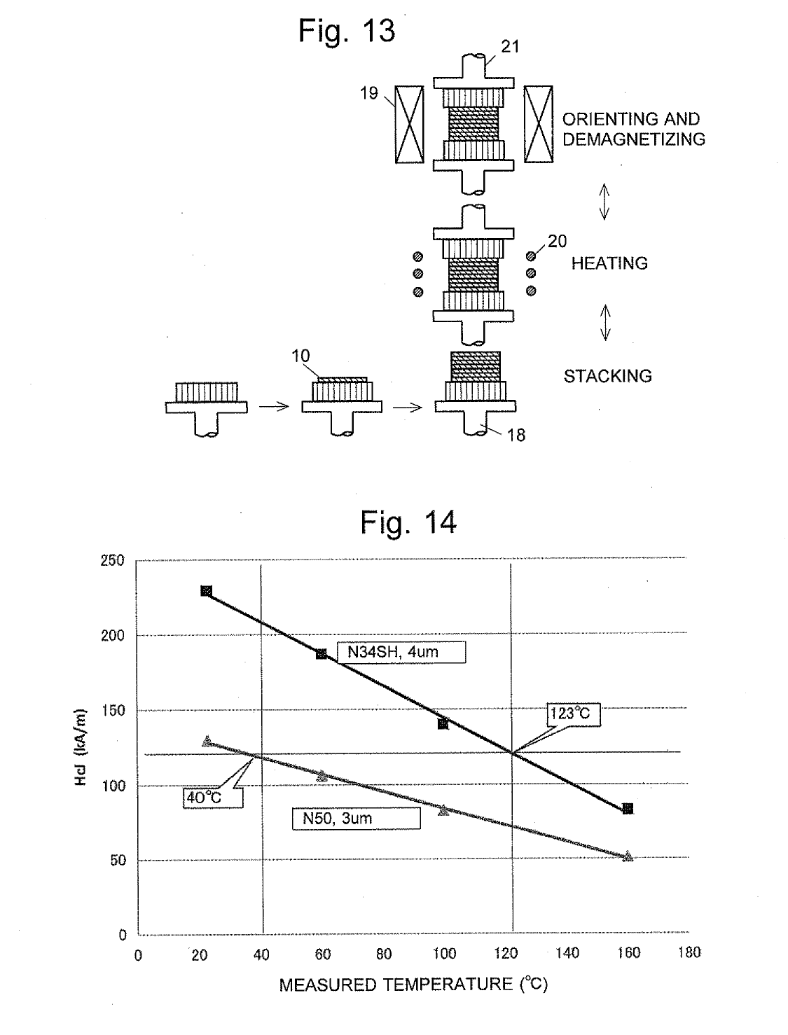

A method for producing a sintered NdFeB magnet using the heating demagnetization is hereinafter described by means of FIGS. 12 and 13. The present variation is identical to the previous embodiment except for the operation in the orienting unit 3. Therefore, the following description is focused solely on the operation of the orienting unit 3 under the control of a controller 22.

Initially, similar to the previous embodiment, molds 10 are stacked on the lift 18 in the orienting unit 3. When a predetermined number of molds 10 have been stacked, the fixing base 21 is lowered to hold the molds 10 from above and below by the fixing base 21 and the lift 18.

After being held by the lift 18 and the fixing base 21 from above and below, the molds 10 are moved into the magnetic-field applying coil 19, where an AC magnetic field (as an orienting magnetic field) is initially applied to orient the alloy powder. After the orientation by the AC magnetic field is completed, the molds 10 are lowered to the level of the induction heating coil 20 and heated to a predetermined temperature. After this heating process, the molds 10 are once more moved into the magnetic-field applying coil 19, where, this time, a DC magnetic field (as an orienting magnetic field) is applied to orient the alloy powder. After the orientation by the DC magnetic field is completed, a damped AC magnetic field (as a demagnetizing magnetic field) with a predetermined peak strength is applied while the molds 10 and the alloy powder 11 are in the heated state, whereby the individual particles of the alloy powder are completely demagnetized. After the demagnetization is completed, the molds 10 are transferred to the sintering furnace and sintered.

A preliminary experiment has revealed that, in the process of demagnetizing the particles of the alloy powder, if the heating temperature of the alloy powder 11 is too low, the coercive force of the powder particles does not adequately decrease, which impedes the formation of the magnetic domains 114 shown in FIG. 2C, so that the particles cannot be completely demagnetized when the damped AC magnetic field is applied. To completely demagnetize the particles of the alloy powder by the application of the damped AC magnetic field, it is necessary to decrease the coercive force of the powder particles to 120 kA/m (≈1.5 kOe) or lower. The temperature dependency of the coercive force of the particles of the alloy powder changes depending on the alloy composition and the average particle size. For example, for two kinds of alloy powders having the compositions shown in Table 9, the temperature dependency will be as shown in FIG. 14.

TABLE 9

| | Alloy Name | | | | | | | |
|---|---|---|---|---|---|---|---|---|
| | Nd | Pr | Dy | Co | B | Al | Cu | Fe |
| N50 | 26.7 | 4.8 | 0 | 0.9 | 0.99 | 0.25 | 0.09 | bal. |
| N43SH | 21.8 | 6 | 4.1 | 0.9 | 0.99 | 0.2 | 0.11 | bal. |

FIG. 14 demonstrates that, for alloy powder N50 having an average particle size of 3 μm, the heating temperature must be 40° C. or higher so as to decrease the coercive force of the powder particles to 120 kA/m (≈1.5 kOe) or lower, and for alloy powder N43SH having an average particle size of 3 μm, the heating temperature must be 123° C. or higher. Furthermore, the upper limit of the heating temperature must be set at 280° C. or lower. Using a heating temperature higher than 280° C. excessively decreases the saturation magnetization and magnetic anisotropy of the particles of the alloy powder, making them unaffected by the application of a magnetic field.

The orienting magnetic field must have a strength of 3T or higher, and if possible, 5T or higher, as in the conventional PLP method. The peak intensity of the damped AC magnetic field applied in the demagnetizing process must exceed the coercive force of the particles of the alloy powder. However, it should not be too high, because an excessively high magnetic field makes the individual particles rotate against the frictional binding among the particles, causing a decrease in the degree of orientation. Table 9 below shows a change in the degree of orientation (Br/Js) of sintered magnets produced from alloy powder N50 with an average particle size of 3.3 μm by performing a demagnetizing process in which the peak strength of the damped AC magnetic field (“AC demagnetization”) applied to the alloy powder was changed from 0 T (no AC demagnetization) through 0.2 T, 0.4 T and 0.6 T. The orientation of the alloy powder was performed in such a manner that a pulsed AC magnetic field of 5.5 T (“AC orientation”) was initially applied two times, after which the powder was heated to 180° C., and 45 seconds later, a pulsed DC magnetic field of 5.5 T (“DC orientation”) was applied. The heating temperature of the alloy powder and the coercive force of the powder particles in the AC demagnetization process were 100° C. and 80 kA/m, respectively.

TABLE 10

| | | Br/Js |
|---|---|---|
| Powder Type | Orienting Condition | (%) |
| N50 3.3 μm | AC Orientation → AC Orientation → Heating → | 96.5 |
| | DC Orientation | |
| | AC Orientation → AC Orientation → Heating → | 96.0 |
| | DC Orientation → AC Demagnetization (0.2 T) | |
| | AC Orientation → AC Orientation → Heating → | 95.8 |
| | DC Orientation → AC Demagnetization (0.4 T) | |
| | AC Orientation → AC Orientation → Heating → | 95.7 |
| | DC Orientation → AC Demagnetization (0.6 T) | |

Table 10 shows that the degree of orientation decreases with an increase in the peak strength of the damped AC magnetic field used for AC demagnetization. To prevent this decrease in the degree of orientation, it is preferable to set the peak strength at 0.6 T or lower, and more preferably 0.3 T or lower. The peak strength of 0.6 T approximately corresponds to a coercive force of 480 kA/m, and 0.3 T approximately corresponds to 240 kA/m. In this manner, the peak strength of the damped AC magnetic field applied for demagnetization must be appropriately set according to the composition and particle size of the alloy powder, the heating temperature, the coercive force of the powder particles and the degree of orientation.

The sintered magnet production system shown in FIG. 5 may additionally be provided with a cooling unit for cooling the molds 10 and the alloy powder 11 while the molds 10 are being transferred to the sintering furnace after the demagnetization by the damped AC magnetic field is completed. This prevents the sintered magnet production system from being heated.

Thus far, the system for producing a sintered NdFeB magnet according to the present invention has been described by means of the embodiment. It is evident that the previous embodiment is a mere example, and any change, modification or addition may be appropriately made within the spirit and scope of the present invention. For example, as an alternative to the damped AC magnetic field used as the demagnetizing magnetic field in the previous embodiment, a DC magnetic field having a strength equal to the peak strength of the aforementioned damped AC magnetic field may be applied in the direction opposite to the direction of magnetization of the alloy powder in the heating orientation process, to demagnetize the alloy powder.

### EXPLANATION OF NUMERALS

1 . . . Filling Unit
2 . . . Containing Unit
3 . . . Orienting Unit
10 . . . Mold
11 . . . Alloy Powder
111 . . . Particles of Alloy Powder
112 . . . Direction of Crystal Axis
113 . . . Direction of Magnetization
114 . . . Magnetic Domain
12 . . . Mold Container
13 . . . Airtight Container
14 . . . Hopper
15 . . . Guide
16 . . . Pusher
17 . . . Tapping Device
18 . . . Lift 18
19 . . . Magnetic-Field Applying Coil
20 . . . Induction Heating Coil
21 . . . Fixing Base
22 . . . Controller

1. A method for producing a sintered NdFeB magnet including a filling process for filling an NdFeB alloy powder into a mold to a density within a range from 3.0 to 4.2 g/cm³, an orienting process for orienting the alloy powder in the mold by a magnetic field, and a sintering process for sintering the oriented alloy powder together with the mold, comprising:
a heating process for heating the alloy powder in the mold before and/or after an application of an orienting magnetic field in the orienting process.

2. The method for producing a sintered NdFeB magnet according to claim 1, wherein a filling density of the alloy powder in the filling process is within a range from 3.5 to 4.0 g/cm³.

3. The method for producing a sintered NdFeB magnet according to claim 1, wherein a heating temperature in the heating process is equal to or higher than 50° C. and equal to or lower than 300° C.

4. The method for producing a sintered NdFeB magnet according to claim 1, wherein a content of Dy in the alloy powder is equal to or higher than 1 wt % and lower than 6 wt %.

5. The method for producing a sintered NdFeB magnet according to claim 1, wherein a strength of the orienting magnetic field is equal to or higher than 3 T.

6. The method for producing a sintered NdFeB magnet according to claim 5, wherein the strength of the orienting magnetic field is equal to or higher than 5 T.

7. The method for producing a sintered NdFeB magnet according to claim 1, wherein the orienting magnetic field is a pulsed magnetic field.

8. The method for producing a sintered NdFeB magnet according to claim 7, wherein an application of the orienting magnetic field is performed by applying an alternate-current magnetic field and a direct-current magnetic field in this order.

9. The method for producing a sintered NdFeB magnet according to claim 7, wherein an application of the orienting magnetic field is performed by applying an alternate-current magnetic field, another alternate-current magnetic field and a direct-current magnetic field in this order.

10. The method for producing a sintered NdFeB magnet according to claim 8, wherein the heating process is performed before an application of the direct-current magnetic field.

11. The method for producing a sintered NdFeB magnet according to claim 8, wherein the heating process is performed after an application of the direct-current magnetic field.

12. The method for producing a sintered NdFeB magnet according to claim 11, wherein a heating temperature in the heating process after the application of the direct-current magnetic field is equal to or higher than 200° C. and equal to or lower than 300° C.

13. The method for producing a sintered NdFeB magnet according to claim 1, wherein a heating method used in the heating process is a radio-frequency induction heating.

14. The method for producing a sintered NdFeB magnet according to claim 13, wherein a central axis of a coil used for the radio-frequency induction heating coincides with a central axis of a coil used for applying the orienting magnetic field.

15. The method for producing a sintered NdFeB magnet according to claim 1, wherein an average particle size of the alloy powder is equal to or larger than 1 μm and equal to or smaller than 5 μm.

16. The method for producing a sintered NdFeB magnet according to claim 15, wherein an average particle size of the alloy powder is equal to or larger than 1 μm and equal to or smaller than 3.5 μm.

17. The method for producing a sintered NdFeB magnet according to claim 1, wherein a heating demagnetization process for applying a demagnetizing magnetic field to the alloy powder maintained in a heated state created by the heating process is provided at an end of the orienting process.

18. The method for producing a sintered NdFeB magnet according to claim 17, wherein the demagnetizing magnetic field is a damped alternating-current magnetic field which is gradually damped from a predetermined peak strength.

19. The method for producing a sintered NdFeB magnet according to claim 18, wherein the peak strength of the damped alternating-current magnetic field applied for demagnetization is higher than a coercive force of powder particles at a temperature in the heating demagnetization process and equal to or lower than 480 kA/m.

20. The method for producing a sintered NdFeB magnet according to claim 19, wherein the peak strength of the damped alternating-current magnetic field applied for demagnetization is equal to or lower than 240 kA/m.

21. The method for producing a sintered NdFeB magnet according to claim 17, wherein the demagnetizing magnetic field is a direct-current magnetic field of a predetermined strength applied opposite to a direction of magnetization of particles of the alloy powder.

22. The method for producing a sintered NdFeB magnet according to claim 21, wherein the strength of the direct-current magnetic field applied for demagnetization is higher than a coercive force of powder particles at a temperature in the heating demagnetization process and equal to or lower than 480 kA/m.

23. The method for producing a sintered NdFeB magnet according to claim 22, wherein the strength of the direct-current magnetic field applied for demagnetization is equal to or lower than 240 kA/m.

24. The method for producing a sintered NdFeB magnet according to claim 17, wherein a temperature of the alloy powder in the heating demagnetization process is equal to or higher than a temperature at which a coercive force of powder particles is 120 kA/m.

25. The method for producing a sintered NdFeB magnet according to claim 17, wherein a temperature of the alloy powder in the heating demagnetization process is equal to or lower than 280° C.

26. The method for producing a sintered NdFeB magnet according to claim 1, wherein a cooling process for cooling the alloy powder and the mold is provided after the orienting process.

27. A system for producing a sintered NdFeB magnet including a filling system for filling an NdFeB alloy powder into a mold to a density within a range from 3.0 to 4.2 g/cm³, an orienting device for orienting the alloy powder in the mold, and a sintering device for sintering the oriented alloy powder together with the mold, wherein the orienting device includes:
a magnetic-field applying device for applying a magnetic field to the alloy powder; and
a heating device for heating the alloy powder in the mold before and/or after the magnetic-field applying device applies an orienting magnetic field to the alloy powder.

28. The system for producing a sintered NdFeB magnet according to claim 27, wherein the magnetic-field applying device fills the alloy powder into the mold to a density within a range from 3.5 to 4.0 g/cm³.

29. The system for producing a sintered NdFeB magnet according to claim 27, wherein the heating device is a radio-frequency induction heating system.

30. The system for producing a sintered NdFeB magnet according to claim 29, wherein a central axis of a coil used for the radio-frequency induction heating coincides with a central axis of a coil used for applying the magnetic field.

31. The system for producing a sintered NdFeB magnet according to claim 27, further comprising a controller for controlling the heating device and the magnetic-field applying device so that, after the alloy powder has been subjected to a heating orientation process by the heating device and the magnetic-field applying device, a demagnetizing magnetic field is applied to the alloy powder maintained in the heated state.

32. The system for producing a sintered NdFeB magnet according to claim 31, wherein the demagnetizing magnetic field is a damped alternating-current magnetic field which is gradually damped from a predetermined peak strength.

33. The system for producing a sintered NdFeB magnet according to claim 32, wherein the peak strength of the damped alternating-current magnetic field is higher than a coercive force of powder particles at a temperature in a process of applying the demagnetizing magnetic field and equal to or lower than 480 kA/m.

34. The system for producing a sintered NdFeB magnet according to claim 33, wherein the peak strength of the damped alternating-current magnetic field is equal to or lower than 240 kA/m.

35. The system for producing a sintered NdFeB magnet according to claim 31, wherein the demagnetizing magnetic field is a direct-current magnetic field of a predetermined strength applied opposite to a direction of magnetization of particles of the alloy powder.

36. The system for producing a sintered NdFeB magnet according to claim 35, wherein the strength of the direct-current magnetic field is higher than a coercive force of powder particles at a temperature in a process of applying the demagnetizing magnetic field and equal to or lower than 480 kA/m.

37. The system for producing a sintered NdFeB magnet according to claim 36, wherein the strength of the direct-current magnetic field is equal to or lower than 240 kA/m.

38. The system for producing a sintered NdFeB magnet according to claim 31, wherein a temperature of the alloy powder in a process of applying the demagnetizing magnetic field is equal to or higher than a temperature at which a coercive force of powder particles is 120 kA/m.

39. The system for producing a sintered NdFeB magnet according to claim 31, wherein a temperature of the alloy powder in a process of applying the demagnetizing magnetic field is equal to or lower than 280° C.

40. The system for producing a sintered NdFeB magnet according to claim 27, wherein a cooling device for cooling the alloy powder and the mold is provided between the orienting device and the sintering device.

41. A magnetic-powder orienting system for a method for producing a sintered NdFeB magnet including a filling process for filling an NdFeB alloy powder into a mold to a density within a range from 3.0 to 4.2 g/cm³, an orienting process for orienting the alloy powder in the mold by a magnetic field, and a sintering process for sintering the oriented alloy powder together with the mold, the magnetic-powder orienting system being designed to be used in the orienting process, comprising:
a heating device for heating the alloy powder;
a magnetic-field applying device for applying a magnetic field to the alloy powder; and
a controller for controlling the heating device and the magnetic-field applying device so as to heat the alloy powder to a predetermined temperature and then apply an orienting magnetic field and a demagnetizing magnetic field to the heated alloy powder.

42. A sintered NdFeB magnet produced by the method according to claim 1, wherein:
a permeance coefficient of a shape of the magnet in an as-sintered state is equal to and higher than 0.01 and lower than 0.5;
a coercive force of the magnet after an additional heat treatment subsequent to the sintering process is equal to or higher than 1.2 MA/m; and
a degree of orientation of the magnet in a thickness direction is equal to or higher than 95%.

43. The sintered NdFeB magnet according to claim 42, wherein the permeance coefficient is equal to and higher than 0.01 and lower than 0.2.

44. A sintered NdFeB magnet, wherein:
a permeance coefficient of a shape of the magnet in an as-sintered state is equal to and higher than 0.01 and lower than 0.5;
a coercive force of the magnet after an additional heat treatment subsequent to the sintering process is equal to or higher than 1.2 MA/m; and
a degree of orientation of the magnet in a thickness direction is equal to or higher than 95%.

45. The sintered NdFeB magnet according to claim 44, wherein the permeance coefficient is equal to and higher than 0.01 and lower than 0.2.

46. The method for producing a sintered NdFeB magnet according to claim 9, wherein the heating process is performed after an application of the direct-current magnetic field.

47. The method for producing a sintered NdFeB magnet according to claim 46, wherein a heating temperature in the heating process after the application of the direct-current magnetic field is equal to or higher than 200° C. and equal to or lower than 300° C.
